(19) United States
(12) Patent Application Publication
(10) Pub. No.: US 2014/0063219 A1
(43) Pub. Date: Mar. 6, 2014

(54) SYSTEM AND METHOD INCLUDING A PORTABLE USER PROFILE FOR MEDICAL IMAGING SYSTEMS

(71) Applicants: Andrew David Stonefield, Wauwatosa, WI (US); Menachem Halmann, Bayside, WI (US)

(72) Inventors: Andrew David Stonefield, Wauwatosa, WI (US); Menachem Halmann, Bayside, WI (US)

(73) Assignee: General Electric Company, Schenectady, NY (US)

(21) Appl. No.: 13/597,036

(22) Filed: Aug. 28, 2012

(51) Int. Cl. H04N 5/30; H04N 7/18

(52) U.S. Cl. 348/77; 348/E05.085

(57) ABSTRACT

A medical imaging system is provided that includes a system controller that is configured to control operation of a medical imaging system. The system controller is configured to receive a user profile from a profile-storage system that is at a distinct location with respect to the medical imaging system. The user profile includes predetermined operational settings that are associated with the operator. Each of the predetermined operational settings is selected from a plurality of potential operational settings that control operation of the medical imaging system. The system controller is configured to load the predetermined operational settings of the user profile, wherein the predetermined operational settings affect at least one of acquisition of a medical image during the imaging session or how the information is displayed to the operator during the imaging session.

### BACKGROUND

The subject matter disclosed herein relates generally to medical imaging systems, and more particularly to a network of medical imaging systems.

A medical imaging system is typically operated by users that have been trained in a type of imaging system and, in some cases, specifically trained in a certain application of that imaging system. Examples of such medical imaging systems include an ultrasound system, magnetic resonance imaging (MRI) system, computed tomography (CT) system, positron emission tomography (PET) system, and single photon emission computed tomography (SPECT) system. An ultrasound system typically includes an ultrasound probe that is applied to a patient's body and a workstation that is operably coupled to the probe. The probe transmits and receives ultrasound signals that are processed into an ultrasound image. The workstation may show the user the ultrasound image and may enable the user to control operation of the probe. To this end, the workstation may have a user interface that includes user-selectable elements (e.g., tangible or virtual knobs, levers, tabs, buttons, and the like) for controlling operation of the ultrasound system.

In some clinical environments (e.g., hospital, doctor's office, and the like), a single ultrasound system may be used to examine several people in a day and/or may be used in different types of examinations. By way of example only, a single ultrasound imaging system may be used to image a baby in a woman's uterus, to image various organs in a patient's abdomen, to image the heart, or to image different parts of the vascular system. Moreover, a single ultrasound system may be used by a number of different operators. Each of the operators may prefer different settings for operating the ultrasound system. As such, an operator of an ultrasound system may have to change one or more settings of the ultrasound system or to select a different workflow for the ultrasound system. Even when an ultrasound system is exclusively used for a particular examination (e.g., echocardiograms) different operators of the ultrasound system may have different preferred settings. Such preferences may affect the quality of images and/or may affect usability of the ultrasound system. However, changing the settings of an ultrasound system may be time consuming and, in some cases, a user may not be able to remember the different settings that he or she prefers until the user has already begun an examination.

In addition to the above, users of the imaging systems may wish to have access to a medical image when the user is no longer at the imaging system that acquired the medical image. For instance, the user may wish to use the medical image in a presentation, for accreditation, or to show the medical image to medical professionals for their opinion. However, medical images are typically stored in a manner that includes identifying information of the patient. As such, systems that allow access to medical images should be consistent with regulatory requirements, such as those relating to the Health Insurance Portability and Accountability Act (HIPAA).

### BRIEF DESCRIPTION

In one embodiment, a medical imaging system is provided that includes a user interface configured to receive user inputs from an operator. The user inputs include identification data that identifies the operator. The user interface includes an operator display configured to display information to the operator during an imaging session. The medical imaging system includes a system controller that is configured to control operation of the medical imaging system. The system controller is configured to receive a user profile from a profile-storage system that is at a distinct location with respect to the medical imaging system. The user profile includes predetermined operational settings that are associated with the operator. Each of the predetermined operational settings is selected from a plurality of potential operational settings that control operation of the medical imaging system. The system controller is configured to load the predetermined operational settings of the user profile, wherein the predetermined operational settings affect at least one of acquisition of a medical image during the imaging session or how the information is displayed to the operator during the imaging session.

In another embodiment, a personal communication device is provided that includes a portable housing that is dimensioned to be carried by an operator. The personal communication device includes a user interface that is coupled to the housing and that is configured to receive user inputs from the operator. The user inputs include identification data that identifies the operator. The user interface includes a personal display configured to display information to the operator. The personal communication device also includes a communication port that is coupled to the housing and that is configured to communicate with a medical imaging system. The personal communication device also includes a device storage component that is coupled to the housing and is configured to store a user profile. The user profile includes predetermined operational settings that are associated with the operator. Each of the predetermined operational settings is selected from a plurality of potential operational settings that control operation of the medical imaging system. The system controller is configured to transmit the user profile to the medical imaging system, wherein the predetermined operational settings affect at least one of acquisition of a medical image during the imaging session or how the information is displayed to the operator during the imaging session.

In another embodiment, a method is provided that includes receiving user inputs from an operator at a user interface of a medical imaging system. The user inputs include identification data that identifies the operator. The method also includes receiving, at the medical imaging system, a user profile from a profile-storage system that is at a distinct location with respect to the medical imaging system. The user profile includes predetermined operational settings that are associated with the operator. The method also includes loading the predetermined operational settings into the medical imaging system, wherein each of the predetermined operational settings is selected from a plurality of potential operational settings that control operation of the medical imaging system. The method also includes imaging a patient during an imaging session. The predetermined operational settings affect at least one of acquisition of a medical image during the imaging session or how the information is displayed to the operator during the imaging session.

### BRIEF DESCRIPTION OF THE DRAWINGS

FIG. 1 illustrates a system network in accordance with one embodiment that includes a plurality of medical imaging systems.

FIG. 2 illustrates a block diagram of an ultrasound system in accordance with one embodiment.

FIG. 3 is a flowchart of a method according to one embodiment.

FIG. 4 illustrates a user interface that may be used with the ultrasound system of FIG. 2.

FIG. 5 is a perspective view of a console-based ultrasound system provided on a movable base in accordance with one embodiment.

### DETAILED DESCRIPTION

Embodiments described herein include systems (e.g., a medical imaging system or a system network having a plurality of medical imaging systems), methods, and computer readable media. Embodiments may be configured to utilize a user profile or a number of different user profiles in which each user profile includes information relating to an operator (e.g., a user) of a medical imaging system. As used herein, a “user profile” includes a collection of information or data relating to an operator of a medical imaging system. The user profile may constitute a package of information or data that is communicated to different components of a system network. A user profile may identify predetermined operational settings of a medical imaging system that are designated or selected from a number of potential operational settings. The predetermined operational settings may be settings selected by the operator for being automatically loaded into the medical imaging system or, more specifically, a program of the medical imaging system when the medical imaging system or the program of the medical imaging system are initiated.

A single operator (e.g., doctor, nurse, technician, or other suitable person) may have multiple user profiles. For instance, an operator may have different user profiles for different medical imaging modalities (e.g., a user profile for ultrasound and a different user profile for PET/CT); an operator may have different user profiles for different models of a common imaging modality (e.g., a first ultrasound system and a second ultrasound system); or an operator may have different user profiles for a common medical imaging system (e.g., a user profile for echocardiography and a different user profile for obstetric ultrasound imaging). Alternatively, a single user profile may include multiple sub-profiles in which each sub-profile includes predetermined operational settings as described herein. Each sub-profile may correspond to a different imaging modality, a different model of a common imaging modality, or a different application of a single medical imaging system. As described in greater detail below, operational settings control operation of the medical imaging system.

In some embodiments, the user profile includes additional information. For example, the user profile may also include one or more of medical image(s); statistical information relating to the operator (e.g., number of scans performed, different medical imaging systems used); accreditation data; and documents that the operator wishes to have readily available. In some cases, the user profile may be directly accessed by the operator (e.g., through the medical imaging system or through a personal communication device) and changes may be made directly to the user profile. For example, a web-based application on the medical imaging system, a personal computer, or a personal communication device may show the operator the data/information that is stored with the user profile, including the predetermined operational settings of the various medical imaging systems for the operator. The application may permit the operator to make changes to the user profile, such as changes to the predetermined operational settings. Accordingly, the operator may change the user profile at a location other than the medical imaging system.

The following detailed description of various embodiments will be better understood when read in conjunction with the appended drawings. To the extent that the figures illustrate diagrams of the functional blocks of the various embodiments, the functional blocks are not necessarily indicative of the division between hardware circuitry. Thus, for example, one or more of the functional blocks (e.g., modules, processors, or memories) may be implemented in a single piece of hardware (e.g., a general purpose signal processor or a block of random access memory, hard disk, or the like) or multiple pieces of hardware. Similarly, the programs may be stand alone programs, may be incorporated as subroutines in an operating system, may be functions in an installed software package, and the like. It should be understood that the various embodiments are not limited to the arrangements and instrumentality shown in the drawings.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

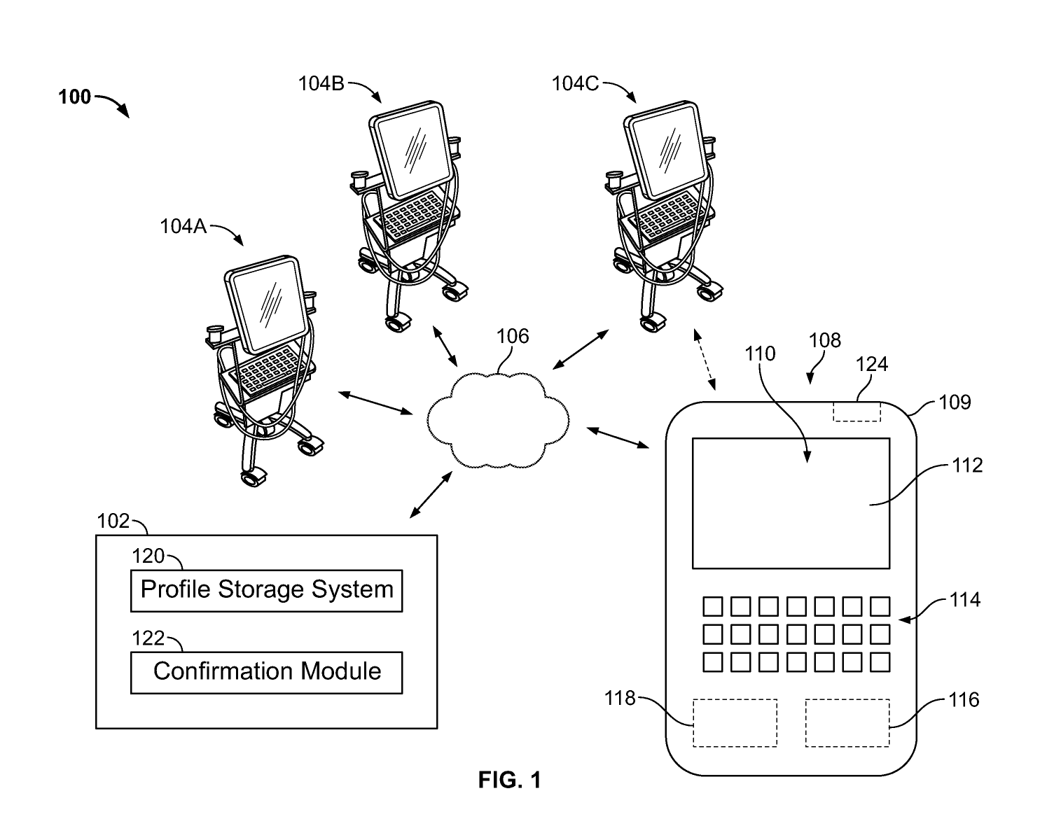

FIG. 1 illustrates a system network 100 that includes a server system 102 and a plurality of medical imaging systems 104A-104C that are configured to communicate with one another and/or the server system 102. The medical imaging systems 104A-104C and the server system 102 may communicate through a telecommunications network 106, which may include, for example, one or more of the Internet, a wide area network (WAN), a local area network (LAN), campus area network, and the like. The medical imaging systems 104A-104C may be various types of medical imaging systems, such as an ultrasound system, a magnetic resonance imaging (MRI) system, a computed tomography (CT) system, a positron emission tomography (PET) system, and a single photon emission computed tomography (SPECT) system, among others. As shown in FIG. 1, in certain embodiments, the medical imaging systems 104A-104C are ultrasound systems and, more particularly, are mobile ultrasound systems that are capable of being moved from one location to another location (e.g., from one room or floor to another room or floor). However, the medical imaging systems may have various sizes and configurations. For example, laptops and handheld devices may be configured to operably couple to an ultrasound probe and function as an ultrasound system. In some embodiments, the system network 100 may also include one or more personal communication devices 108.

The server system 102 includes a computing system that provides services to other components of the system network 100 (e.g., the medical imaging systems 104 and/or the personal communication devices 108) and may communicate through the telecommunications network 106. The server system 102 may include one or more servers that are configured to manage resources of the system network 100. For example, the server system 102 may receive data, process the data in a designated manner, store the data, and/or transmit the data to other components that are communicatively coupled to the telecommunications network 106. The server system 102 may respond to requests from the other components. The server system 102 may have a distinct location with respect to the other components. For example, the server system 100 may be remote from the medical imaging systems 104A-104C and from the personal communication devices 108. In FIG. 1, the server system 100 appears to have one location, however; it should be understood that the server system 100 may comprise several components that have separate locations.

In certain embodiments, the server system 102 includes a profile-storage system 120 that is configured to store user profiles of operators that use the medical imaging systems 104 of the system network 100. As described above, the user profiles may include information or data that identifies predetermined operational settings for a user of a medical imaging system. Each operational setting may be designated or selected from a number of potential operational settings. The predetermined operational settings may be selected by the operator that is associated with (e.g., that corresponds to) the user profile. In some cases, the operational settings are selected by the user as preferred operational settings such that the selected operational settings are loaded into the medical imaging system each time the medical imaging system is initiated or loaded into an application each time the application is initiated. In some embodiments, the operational settings may be the operational settings that were last used by the operator prior to logging off of the medical imaging system or the application.

The profile-storage system 120 is configured to communicate (e.g., transmit) one or more user profiles to the medical imaging system 104. For instance, the profile-storage system 120 may transmit one or more user profiles to the medical imaging system 104A. The profile-storage system 120 may identify the user profile(s) to send to the medical imaging system 104A in response to communications from the medical imaging system 104. For instance, the server system 102 may include a confirmation module 122 that is configured to receive identifying data from the medical imaging system 104A and confirm that the identifying data corresponds to a user profile. The identifying data may be, for example, a username and password that are used by the operator or other information. In some embodiments, the user profile is requested by the medical imaging system when the operator is initially logging onto the medical imaging system. In other embodiments, the user profile is requested only after the operator has initiated a certain program on the medical imaging system 104A. After the identity of the operator is confirmed, the profile-storage system 120 may select the user profile that is associated with the operator from the other user profiles and transmit the user profile to the medical imaging system 104. In some embodiments, the medical imaging system 104 may be used to store a backup of the user profile.

The personal communication devices 108 may constitute portable handheld devices, such as smartphones, tablet computers, and the like. Portable handheld devices may be dimensioned to be easily carried by an average adult. For example, the personal communication device 108 may have a housing 109 that is dimensioned to be carried by the operator. As shown, the personal communication device 108 may include a user interface 110 that includes a personal display 112 and a plurality of user-selectable elements 114. The user interface 110 may include hardware, firmware, software, or a combination thereof that enables an operator (e.g., an owner of the personal communication device 108) to directly or indirectly control operation of the personal communication device 108.

The user-selectable elements 114 may be activated by the operator to provide user inputs to the personal communication device 108. The user-selectable elements 114 may include keys of a keyboard, switches, a touchpad, and the like. The user-selectable elements may be physical or virtual. For instance, the personal display 110 may be a touch-sensitive display (e.g., touchscreen) that can detect a presence of a touch from the operator (e.g., owner of the personal communication device 108) and can also identify a location of the touch in the display area. The touch may be applied by, for example, at least one of an operator's hand, stylus, or the like. As such, the touch-sensitive display may receive user inputs from the operator and also display information to the operator. During operation of the personal communication device 108, the personal display 112 may include or form the user-selectable elements 114. For instance, graphical objects shown on the personal display 112 may resemble buttons, switches, sliders, and the like.

The personal communication device 108 may also include a device controller 116 (e.g., having one or more modules), one or more device storage components 118, and one or more communication ports 124. The device controller 116 controls operation of the personal communication device 108 and may include a plurality of modules for carrying out other functions of the personal communication device 108. The device storage component 118 may include storage components that are integral to the personal communication device 108 and may also include removable storage components 118 (e.g., SIM cards). As will be described in greater detail below, the device storage component 108 may function as a profile-storage system and store one or more user profiles associated with the operator (e.g., owner of the personal communication device 108). The communication port 124 may include hardware and/or software components that are configured to communicate data between the personal communication device 108 and the other components of the system network 100, such as the server system 102. For example, the communication ports 124 may be an antenna or a universal serial bus (USB) port. In some examples, the communication ports 124 may be characterized as input/output ports. In such cases where the personal communication device 108 is a smartphone or tablet computer, the communication port 124 may be an antenna that is used for communication in the telecommunications network 106 and in other telecommunications networks.

The system network 100 may be characterized as a cloud-computing network. For example, many of the resources of the system network 100 may be shared by various components of the system network 100. The server system 102 may be configured to perform similar services for each of the medical imaging systems 104 and/or the personal communication devices 108. More specifically, the server system may be configured to operate or execute identical or similar algorithms for each of the medical imaging systems 104 and/or the personal communication devices 108. The services may relate to analysis and/or processing of medical images.

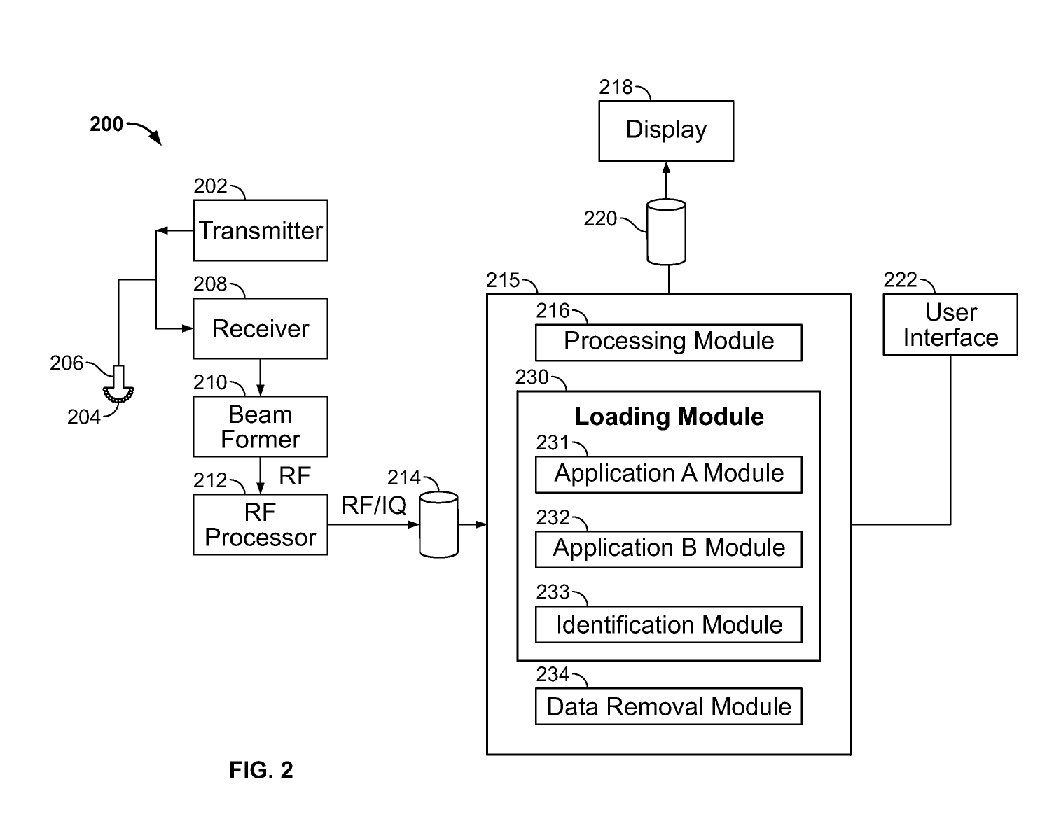

FIG. 2 illustrates a block diagram of an ultrasound system 200 according to one embodiment. The ultrasound system 200 may be one of the medical imaging systems 104A-104C (FIG. 1) and be part of the system network 100 (FIG. 1). In the illustrated embodiment, the ultrasound system 200 includes a transmitter 202 that drives an array of elements 204, for example, piezoelectric crystals, within a transducer 206 to emit pulsed ultrasonic signals into a body or volume (not shown). A variety of geometries may be used and the transducer 206 may be provided as part of, for example, different types of ultrasound probes. The ultrasonic signals are back-scattered from structures in the body, for example, blood cells or muscular tissue, to produce echoes that return to the elements 204. The echoes are received by a receiver 208. The received echoes are provided to a beamformer 210 that performs beamforming and outputs an RF signal. The RF signal is then provided to an RF processor 212 that processes the RF signal. Alternatively, the RF processor 212 may include a complex demodulator (not shown) that demodulates the RF signal to form IQ data pairs representative of the echo signals. The RF or IQ signal data may then be provided directly to a computer-readable memory 214 for storage (for example, temporary storage).

The ultrasound system 200 also includes a system controller 215 that includes a plurality of modules. The system controller 215 is configured to control operation of the ultrasound system. For example, the system controller 215 may include a processing module 216 that processes the acquired ultrasound data (for example, RF signal data or IQ data pairs). The processing module 216 may prepare frames of ultrasound information (e.g., ultrasound images) for display on a display device 218. The processing module 216 is adapted to perform one or more processing operations according to a plurality of selectable ultrasound modalities on the acquired ultrasound information. By way of example only, the ultrasound modalities may include color-flow, acoustic radiation force imaging (ARFI), B-mode, A-mode, M-mode, spectral Doppler, acoustic streaming, tissue Doppler module, C-scan, and elastography.

Acquired ultrasound information may be processed in real-time during an imaging session (or scanning session) as the echo signals are received. Additionally or alternatively, the ultrasound information may be stored temporarily in the memory 214 during an imaging session and processed in less than real-time in a live or off-line operation. A computer-readable image memory 220 is included for storing processed frames of acquired ultrasound information that are not scheduled to be displayed immediately. The image memory 220 may comprise any known data storage medium, for example, a permanent storage medium, removable storage medium, and the like.

The system controller 215 is connected to a user interface 222 that may enable control of at least some operations of the processing module 216 and is configured to receive user inputs from a user of the system 100. In some embodiments, the user interface 222 includes the display device 218 and is configured to present information relating to the patient, including diagnostic ultrasound images to the user for review, diagnosis, and analysis. The user interface 222 (or the display device 218) may automatically display, for example, planes from two-dimensional (2D) and/or three-dimensional (3D) ultrasound data sets stored in the memory 214 or the image memory 220. One or both of the memory 214 and the memory 220 may store 3D data sets of the ultrasound data, where such 3D data sets are accessed to present 2D and 3D images. The processing of the data, including the data sets, is based in part on user inputs, for example, user selections received at the user interface 222.

In operation, the ultrasound system 200 acquires data, for example, volumetric data sets by various techniques (for example, 3D scanning, real-time 3D imaging, volume scanning, 2D scanning with transducers having positioning sensors, freehand scanning using a voxel correlation technique, scanning using 2D or matrix array transducers, and the like). Ultrasound images are displayed to an operator or user of the system 200 on the display device 218.

The system controller 215 also includes a loading module 230, which may include a plurality of sub-modules 231-233. The loading module 230 is configured to load an application for operating the medical imaging system, which may include, for example, loading operational settings from a portable user profile. The loading may include loading the operational settings when an application is initiated and may also include updating or modifying an active application with the operational settings of the user profile. The loading module 230 may be configured to load application modules, such as Application A module 231 and Application B module 232. The application modules 231, 232 may correspond to stored programs or applications that are configured to guide the user along predetermined workflows. For example, Application A module 231 may correspond to a liver/gallbladder imaging program that guides the user in obtaining ultrasound images of the liver and/or gallbladder. The Application B module 232 may correspond to an echocardiogram imaging program that includes a workflow that guides the user in obtaining ultrasound images of the heart. When application modules are initiated, the loading module 230 may be configured to load the corresponding program with predetermined operational settings of a user profile.

Alternatively, the loading module 230 may load the predetermined operational settings of the user profile after the programs are already active. For instance, when an application is open, the user may select a user profile from a list of user profiles.

The system controller 215 is configured to receive a portable user profile from a profile-storage system, such as the profile-storage system 120 (FIG. 1), that is at a distinct location with respect to the ultrasound system 200. In some embodiments, the system controller 215 includes an identification module 233 that is configured to transmit a request to the profile-storage system 120. The identification module 233 may be part of the loading module 230 or may be separate from the loading module 230. The request may include data for identifying the user profile associated with the operator. The request may be transmitted at different times during activation of the medical imaging system. The request may be transmitted when the operator logs onto the ultrasound system. For example, the user may enter a username and password. In response to the operator logging onto the ultrasound system 200, the server system 102 may transmit the requested user profile.

In embodiments in which the user profile includes a plurality of sub-profiles, the loading module 230 and/or the identification module 233 may identify the sub-profile that should be loaded. For example, if the application that requested the user profile is for echocardiography, the loading module and/or the identification module 233 may select the sub-profile that corresponds to the echocardiography workflow. If a corresponding sub-profile does not exist, the application may use the factory or default operational settings.

Also shown in FIG. 2, the system controller 215 may also include a data-removal module 234 that is configured to process image data to remove identifying information of a patient that is associated with the image data. For example, the operator may desire to transfer the medical image from the medical imaging system. To this end, the operator may enter user inputs that include data-removal inputs instructing the data-removal module to generate an anonymous image with the identifying information removed. The data-removal module 234 may remove the identifying information (e.g., name, identification numbers, demographic data, etc.). In some embodiments, after the identifying information is removed, the anonymous image is stored with the user profile. Before or when the anonymous image is stored with the user profile, the anonymous image may have different identifying information coupled to the image. For example, the anonymous image may be renamed or labeled in a manner that identifies an anatomical structure shown by the anonymous image (e.g., shoulder, cross-section of liver, etc.). The re-identification may be automatic or require user inputs. The re-identifying operation may be executed by the data-removal module.

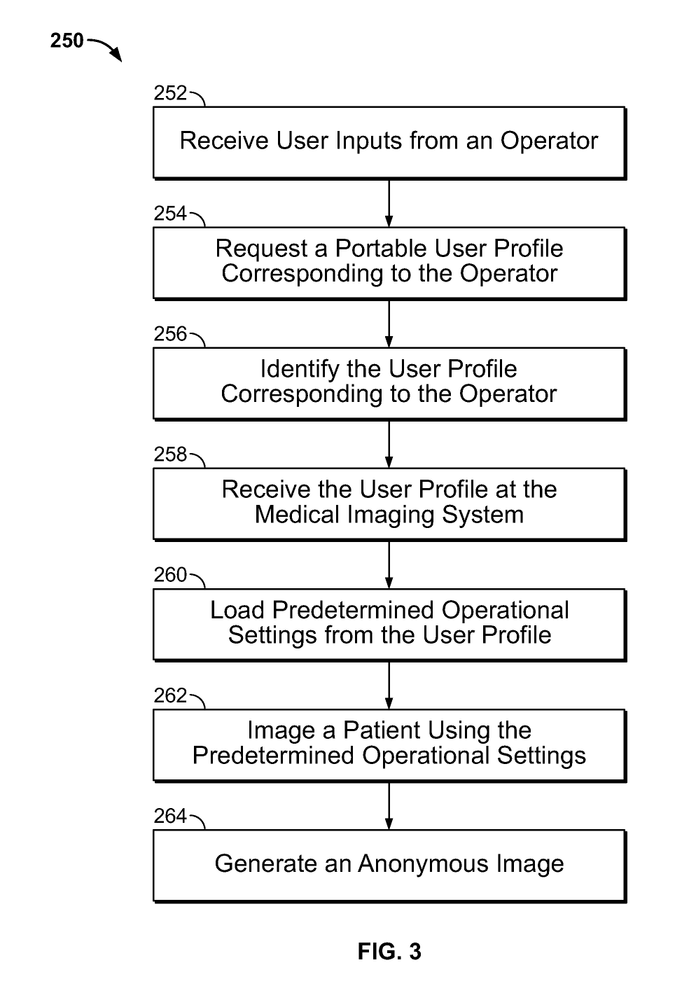

FIG. 3 is a flowchart of a method 250 according to one embodiment. The method 250 may be executed or performed using, for example, the system network 100 (FIG. 1), the medical imaging systems 104A-104C (FIG. 1), and/or the ultrasound system 200. In some embodiments, the method 250 may include receiving at 252 user inputs from an operator at a user interface of a medical imaging system. The user inputs may include identification data that identifies the operator. For example, the identification data may be at least one of a username, a password, or a key code that is entered by the operator through the user interface (e.g., the user interface 222). The identification data may be biometric information obtained through a retinal scan, fingerprint scan, facial-recognition software, voice-recognition software, among others. The identification data may correspond to an individual user (also referred to as the operator) that desires to use the medical imaging system.

In some embodiments, the method 250 may include requesting at 254 a user profile that corresponds to the operator from a profile-storage system, such as the profile-storage system 120 or the device storage component 118. In some embodiments, the requesting operation at 254 may include prompting by the user interface. For example, the user interface may be instructed to query the operator “Retrieve user profile?” or “Please select the user profile to be retrieved.” Based on the user inputs, a user-profile request may be sent to the profile-storage system.

However, the requesting operation at 254 may also be automated without additional actions from the operator. For example, the medical imaging system may transmit a user-profile request to a server system, such as the server system 102, when the operator initiates operation of the medical imaging system (e.g., logs into the medical imaging system or system network). The medical imaging system may also transmit a user-profile request to the server system when an application of the medical imaging system desires to obtain the user profile. For example, the operator may select an echocardiograph application in order to obtain an echocardiogram of a patient. When the application is initiated, the medical imaging system may send a user-profile request to the server system. In some embodiments, the application may send the user-profile request when voluntarily requested by the operator. For example, after the application is activated, the operator may request a user profile by selecting a suitable user-selectable element.

The user-profile request may include operator data that identifies the operator of the medical imaging system. In some cases, the user-profile request may also include additional information, such as system data and/or application data. System data may identify at least one of the modality or model. More specifically, the system data may identify a serial number that corresponds to an individual medical imaging system. The application data may include data that identifies the application that sent the user-profile request and/or a type of examination that will be performed by the medical imaging system. For instance, the application data may include information that identifies the software package and/or the type of medical examination that will be performed (e.g., ultrasound of liver/gallbladder). The user profile may be selected by the server system based on the operator data, system data, and/or the application data.

A user profile may be identified at 256 from a plurality of user profiles in the profile-storage system. The identifying operation at 256 may include analyzing a data structure (e.g., table or database) that includes a plurality of user profiles that are each associated with an operator. Each of the user profiles may correspond to a name and/or an identification number. In embodiments in which a single operator has a plurality of user profiles, the identification operation at 256 may also include selecting a user profile from a set of user profiles that correspond to the single operator. For example, a single operator may have an ultrasound user profile and a PET/CT user profile. The system data and/or application data may be analyzed to determine which of the user profiles to select.

As described above, in some embodiments, a user profile may include multiple sub-profiles. For example, the user profile may include a first sub-profile that identifies operational settings of an ultrasound system executing a first type of workflow, a second sub-profile that identifies operational settings of an ultrasound system executing a second type of workflow, and a third sub-profile that identifies operational settings of a PET/CT system executing a third type of workflow. At 258, the medical imaging system may receive a user profile.

In other embodiments, the requesting operation at 254, the identifying operation at 256, and the receiving operation at 258 may be executed with a personal communication device, such as the personal communication device 108. For example, the requesting operation 254 may be sent to the personal communication device 108 either directly or through the telecommunications network 106 and the server system 102. For example, the personal communication device 108 and the medical imaging system may be capable of communicating with each other when the personal communication device 108 and the medical imaging system are within a predetermined distance. The personal communication device 108 and the medical imaging system may communicate with each other according to an established communication standard (e.g., Bluetooth) or similar standard.

In some embodiments, the medical imaging system may send a user-profile request to the personal communication device 108 or, in other embodiments, the personal communication device 108 may transmit the user profile to the medical imaging system without a specific request. The user profile may be stored in the personal communication device 108 (e.g., in the device storage component 118). Accordingly, the receiving operation at 258 may include receiving a user profile from the personal communication device 108.

At 260, the predetermined operational settings in the user profile are loaded into the medical imaging system. In such embodiments where the user profile includes multiple sub-profiles, the loading operation at 260 may include selecting the suitable sub-profile. Each of the predetermined operational settings may be selected from a plurality of potential operational settings that control operation of the medical imaging system. By way of example, the predetermined operational settings may be loaded into the medical imaging system as the medical imaging system is being initiated (e.g., after the operator logs onto the medical imaging system) or as an application is being initiated (e.g., after the operator selects an application to run). The predetermined operational settings may also be loaded into the medical imaging system after the application using the user profile is already active.

The method 250 may also include imaging at 262 a patient during an imaging session using the predetermined operational settings. In some embodiments, the predetermined operational settings affect at least one of acquisition of a medical image during the imaging session or how information is displayed to the operator during the imaging session. The operational settings affect (e.g., produce an effect upon, influence, determine, etc.) the image acquisition when the operational settings affect how the image data is obtained from the patient or how the medical image is derived from the image data. For example, the operational settings may affect the ultrasound signals that are transmitted into the patient's body and/or the reception of the ultrasound signals. The operational settings may also affect the acquisition when the operational settings affect how the received ultrasound signals are processed and/or analyzed to form the medical image.

The operational settings may include imaging parameters that affect the medical image (e.g., type of medical image, quality of the medical image, orientation or view of the volume of interest (VOI) in the medical image, or a size and shape of the volume of interest in the medical image). Specific examples of imaging parameters may include one or more of a depth of field of view in an ultrasound image, the gain of an ultrasound image, the frequency of ultrasound signals emitted by the probe, a focal position of the ultrasound waves emitted by the probe, and the imaging mode used to obtain the ultrasound image (e.g., B-mode, color, pulsed wave (“PW”), power Doppler Imaging (“PDI”), or M-mode imaging).

In each of the above examples, the predetermined operational setting may be an operational setting that the operator is capable of selecting among other potential operational settings. For instance, an operator may be capable of selecting the frequency to be 5 MHz over other possible frequencies. By loading the predetermined operational settings before imaging the patient, a duration of the imaging session may be shortened and/or fewer mistakes may occur. However, it should be noted that the operator may be enabled to change, during the imaging session, at least one of the predetermined operational settings.

In some embodiments, if the operator changes any of the predetermined operational settings, the user profile at the medical imaging system may be updated to include the changes. After the operator has completed a workflow or decides to log out of the medical imaging system, the medical imaging system may synchronize the user profile at the medical imaging system with the stored version of the user profile at the server system (or at the personal communication device). For example, the medical imaging system may communicate with the corresponding profile-storage system to determine if the two versions of the user profile are identical. If not, the user profile at the profile-storage system may be synchronized with the user profile at the medical imaging system. More specifically, operational settings that were changed by the operator at the medical imaging system may be changed in the user profile at the profile-storage system. In some cases, the medical imaging system may prompt or ask the operator if he or she desires the user profiles to be synchronized. In other embodiments, the synchronization is automatic.

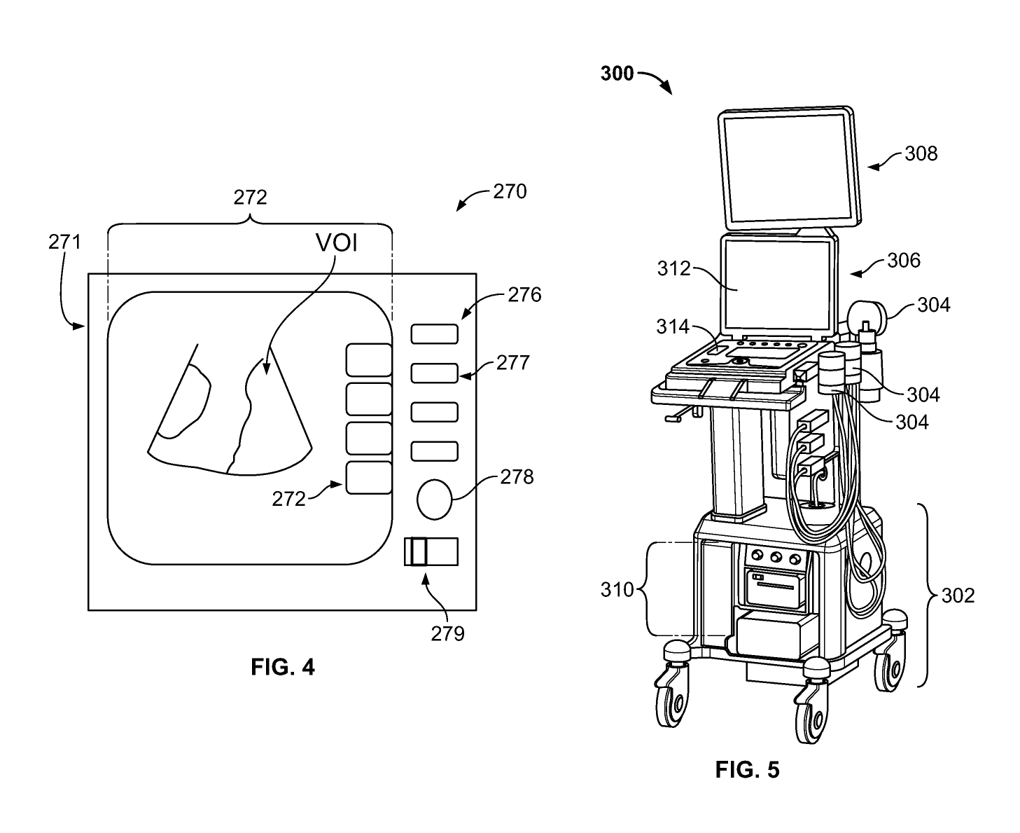

FIG. 4 illustrates a user interface 270, which may function as the user interface 222 (FIG. 2) of the ultrasound system 200. As described above, the operational settings may also affect the information that is displayed to the operator during the imaging session. For example, the operational settings may affect the type, number, and/or quality of graphics that are displayed to the operator. The operational settings may also affect a location of where graphics are located on an operator display or where user-selectable elements are located with respect to the operator. The operational settings may also designate a user-selectable element to a particular utility. As yet another example, the operational settings may also affect a timing or sequence of how information is displayed to the operator. Examples of the above are described and/or illustrated with respect to the user interface 270 in FIG. 4. However, it should be noted that the user interface 270 is exemplary only and other types, styles, and configurations of user interfaces may be implemented.

The user interface 270 may include hardware, firmware, software, or a combination thereof that enables the operator to directly or indirectly control operation of the medical imaging system. The user interface 270 includes an operator display 271 having a display area 272 where a medical image of a VOI in a patient may be displayed. In FIG. 4, the display area 272 may be part of a touch-sensitive display (e.g., touchscreen) that can detect a presence of a touch from the operator and can also identify a location of the touch in the display area 272. As such, the touch-sensitive display may receive user inputs from the operator and also communicate information (e.g., display information) to the operator.

As shown in FIG. 4, the display area 272 may include virtual user-selectable elements 274 that are provided by, for example, a system controller such as the system controller 215. The user-selectable elements may resemble tabs or buttons on the display area 272. In addition to virtual elements, the user interface 270 may also include tangible user-selectable elements 276 that may be touched (e.g., gripped, pressed, moved, and the like) by the operator to be activated. As shown, the user-selectable elements 276 include buttons 277, a rotatable knob 278, and a slider 279.

As described above, the operational settings of the user profile may affect the type, number, and/or quality of graphics that are displayed to the operator. For example, there are four virtual user-selectable elements 274 in the display area 272. The user-selectable elements 274 may control operation of the medical imaging system during the imaging session or provide information to the operator. The predetermined operational settings of the user profile may identify that only those user-selectable elements 274 shown in FIG. 4 may be shown during the imaging session. For example, each of the user-selectable elements 274 may represent a different stage in a workflow. If the operator does not wish to perform one portion of the workflow, then a user-selectable element that represents that portion may not be shown. Accordingly, by utilizing the portable user profile described herein, it would not be necessary for the operator to remove the user-selectable element from the display area 272.

The operational settings may also affect a location of where graphics are located on an operator display or where user-selectable elements are located with respect to the operator. In some cases, different operators may prefer different screen displays. As such, the operational settings may determine where the user-selectable elements 274 are to be located. Moreover, the operational settings may also designate a user-selectable element to a particular utility. For example, in some cases, a first operator may designate that the rotatable knob 278 is to be used to change gain. However, a second operator may prefer that the rotatable knob 278 be used to change the frequency or depth. Accordingly, the predetermined operational settings of the first and second operators may reflect these differences.

Moreover, the operational settings may affect a timing or sequence of when information is displayed to the operator. This may include displaying or not displaying the information entirely. For example, in some embodiments, the operator may prefer to display the imaging parameters on the display area. However, other operators may not wish to display the imaging parameters. As another example, an operator may prefer to display a representative image (e.g., an ideal image) to the operator to aid the operator in determining whether the medical image is sufficient. However, other operators may prefer to use the additional space on the display area 272 and, therefore, prefer to not include the representative image. Again, the predetermined operational settings of the first and second operators may reflect these differences.

Returning to FIG. 3, the method 250 may include generating at 264 an anonymous image based on an acquired medical image at the medical imaging system. In various situations, the operator may desire to transfer one or more of the medical images taken during an imaging session. For example, the operator may wish to show the medical image to other professionals for their opinion or the operator may wish to use the medical image in a presentation or for accreditation. However, medical images acquired during imaging sessions are typically tagged with identifying information that is associated with the patient. For example, the medical image may include a name of the patient, identification number of the patient, or demographic information of the patient.

Accordingly, in some embodiments, the generating operation 264 may include removing the identifying information from the medical image to generate the anonymous image. The generating operation 264 may occur at the medical imaging system by, for example, a data-removal module so that the identifying information is never transferred beyond the medical imaging system.

FIG. 5 is a perspective view of a console-based ultrasound imaging system 300 provided on a movable base 302 in accordance with one embodiment. The system 300 may be similar to the systems 104A-104C (shown in FIG. 1) or the system 200 (shown in FIG. 2). For example, the system 300 may include one or more transducers 304 that are similar to the transducer 206 (shown in FIG. 2), a user interface 306 that is similar to the user interface 222 (shown in FIG. 2) and a display device 308 that is similar to the display device 218 (shown in FIG. 2) in one embodiment. The system 300 includes a system controller 310 that includes one or more transmitters that may be similar to the transmitter 202 (shown in FIG. 2), a receiver (not shown) that is similar to the receiver 208 (shown in FIG. 2), a beam former (not shown) that is similar to the beam former 210 (shown in FIG. 2), an RF processor (not shown) that is similar to the RF processor 212 (shown in FIG. 2), and one or more computer-readable storage media (not shown) that are similar to one or more of the memories 214, 220 (shown in FIG. 1). The system controller 310 may be embodied in one or more computers, computing systems, microprocessors, servers, and the like. The user interface 306 may include a laptop computer having docking functionality with the movable base 302.

In the illustrated embodiment, the user interface 306 includes a secondary display device 312 and an input device 314. The secondary display device 312 may be similar to the display device 218 (shown in FIG. 2). In one embodiment, the secondary display device 312 does not include any touch sensitive portions. For example, no part of the secondary display device 312 includes a touch screen in one embodiment. As shown in FIG. 5, the input device 314 may include a keyboard. Alternatively, the input device 314 may include one or more additional or different input devices such as a mouse, microphone, and the like. The secondary display device 312 and the input device 314 are similar to the displays and input devices of known ultrasound imaging systems in one embodiment. The ultrasound data obtained by the transducer 304 and the ultrasound images formed by the controller 310 may be displayed on the secondary display device 312. One or more adjustments to the ultrasound images displayed on the secondary display device 312 may be made using the input device 314. For example, an operator may use a keystroke to change the operating frequency or imaging mode of the ultrasound image displayed on the secondary display device 312.

It should be noted that although one or more embodiments may be described in connection with an ultrasound system, the embodiments described herein are not limited to ultrasound systems. In particular, one or more embodiments may be implemented in connection with different types of medical imaging systems.

At least one technical effect of one or more embodiments described herein includes a portable user profile that may be used to load predetermined operational settings of an operator of a medical imaging system. By loading predetermined operational settings from a user profile, the duration of imaging sessions may be reduced. Another technical effect may include using a personal communication device to store and transfer the user profile. As such, it may not be necessary for an operator to be registered with a particular system network.

In one embodiment, a medical imaging system is provided that includes a user interface configured to receive user inputs from an operator. The user inputs may include identification data that identifies the operator. The user interface may include an operator display configured to display information to the operator during an imaging session. The medical imaging system may also include a system controller that is configured to control operation of the medical imaging system. The system controller may be configured to receive a user profile from a profile-storage system that is at a distinct location with respect to the medical imaging system. The user profile may include predetermined operational settings that are associated with the operator, wherein each of the predetermined operational settings may be selected from a plurality of potential operational settings that control operation of the medical imaging system. The system controller may also be configured to load the predetermined operational settings of the user profile, wherein the predetermined operational settings may affect at least one of acquisition of a medical image during the imaging session or how the information is displayed to the operator at the operator display during the imaging session.

In one or more aspects, the operator may be a first operator and the system controller may be configured to receive another user profile from the profile-storage system. The other user profile may include predetermined operational settings that are associated with a different second operator, wherein each of the predetermined operational settings of the second operator is selected from the plurality of potential operational settings. At least one of the predetermined operational settings of the first operator may be different from the predetermined operational settings of the second operator.

In one or more aspects, the user inputs may include an operational input that instructs the system controller to change, during the imaging session, at least one of the predetermined operational settings to a different operational setting that is among the plurality of potential operational settings.

In one or more aspects, the system controller may include an identification module that is configured to transmit a user-profile request to the profile-storage system. The user-profile request may include data for identifying the user profile associated with the operator.

In one or more aspects, the medical imaging system is an ultrasound system that includes an ultrasound probe operably coupled to the system controller. Operation of the ultrasound probe is controlled by the system controller. In some embodiments, the operational settings affect at least one of (a) ultrasound signals that are transmitted by the probe or (b) processing of ultrasound signals received by the probe. In some embodiments, the operational settings affect how the information is displayed to the operator.

In one or more aspects, the system controller may include a data-removal module that is configured to process image data to remove identifying information of a patient that is associated with the image data. The user inputs include data-removal inputs that instruct the data-removal module to generate an anonymous image with the identifying information removed.

In another embodiment, a personal communication device is provided that includes a portable housing dimensioned to be carried by an operator and a user interface that is coupled to the housing and configured to receive user inputs from the operator. The user inputs may include identification data that identifies the operator. The user interface may include a personal display configured to display information to the operator. The personal communication device may also include a communication port that is coupled to the housing and configured to communicate with a medical imaging system. The personal communication device may also include a device storage component that is coupled to the housing and configured to store a user profile. The user profile includes predetermined operational settings that are associated with the operator, wherein each of the predetermined operational settings is selected from a plurality of potential operational settings that control operation of the medical imaging system. The system controller is configured to transmit the user profile to the medical imaging system. The predetermined operational settings affect at least one of acquisition of a medical image during the imaging session or how the information is displayed to the operator during the imaging session.

In one or more aspects, the device storage component is configured to receive an anonymous image. The anonymous image may be a medical image of a patient in which identifying information of the patient has been removed. The user interface configured to display the anonymous image.

In one or more aspects, the user profile is directed to a first type of examination. The device storage component is configured to store another user profile that is directed to a different second type of examination. The other user profile may include predetermined operational settings that are associated with the operator for the second type of examination, wherein the first and second types of examination are performed by a common imaging modality.

In one or more aspects, the medical imaging system is an ultrasound system and the operational settings affect ultrasound signals that are transmitted and/or received by an ultrasound probe. In some embodiments, the operational settings determine how the information is displayed to the operator.

In one or more aspects, the personal communication device includes an application module that is configured to receive a user-profile request from the medical imaging system. The application module is configured to transmit the user profile in response to the user-profile request. In some embodiments, the user-profile request identifies the medical imaging system to be used during the imaging session. The user profile may be selected from a plurality of user profiles based on the identified medical imaging system.

In another embodiment, a method is provided that includes receiving user inputs from an operator at a user interface of a medical imaging system. The user inputs may include identification data that identifies the operator. The method may also include receiving, at the medical imaging system, a user profile from a profile-storage system that is at a distinct location with respect to the medical imaging system. The user profile includes predetermined operational settings that are associated with the operator. The method may also include loading the predetermined operational settings into the medical imaging system, wherein each of the predetermined operational settings is selected from a plurality of potential operational settings that control operation of the medical imaging system. The method may also include imaging a patient during an imaging session, wherein the predetermined operational settings affect at least one of acquisition of a medical image during the imaging session or how information is displayed to the operator during the imaging session.

In one or more aspects, the method may also include permitting the operator to change, during an imaging session, at least one of the predetermined operational settings to a different operational setting that is among the plurality of potential operational settings.

As used herein, the term “computing system” or “system controller” may include any processor-based or microprocessor-based systems including systems using microcontrollers, reduced instruction set computers (RISC), application specific integrated circuits (ASICs), logic circuits, and any other circuit or processor capable of executing the functions described herein. The above examples are exemplary only, and are thus not intended to limit in any way the definition and/or meaning of the term “computing system” or “system controller.”

Sets of instructions may include various commands that instruct the computing system or system controller as a processing machine to perform specific operations such as the methods and processes described herein. The set of instructions may be in the form of a software program or module. The software may be in various forms such as system software or application software. Further, the software may be in the form of a collection of separate programs, a program module (or module) within a larger program, or a portion of a program module. The software also may include modular programming in the form of object-oriented programming. The processing of input data by the processing machine may be in response to user commands, or in response to results of previous processing, or in response to a request made by another processing machine. The program is complied to run on both 32-bit and 64-bit operating systems. A 32-bit operating system like Windows XP™ can only use up to 3 GB bytes of memory, while a 64-bit operating system like Window's Vista™ can use as many as 16 exabytes (16 billion GB). A Linux-based system may also be used.

As used herein, the terms “software” and “firmware” are interchangeable, and include any computer program stored in memory for execution by a computing system, including RAM memory, ROM memory, EPROM memory, EEPROM memory, and non-volatile RAM (NVRAM) memory. The above memory types are exemplary only, and are thus not limiting as to the types of memory usable for storage of a computer program.

In yet another embodiment, a tangible non-transitory computer readable medium, excluding signals, is provided that is programmed to instruct a computing system to receive user inputs from an operator at a user interface of a medical imaging system. The user inputs include identification data that identifies the operator. The computing system is also instructed to receive, at the medical imaging system, a user profile from a profile-storage system that is at a distinct location with respect to the medical imaging system. The user profile includes predetermined operational settings that are associated with the operator. The computing system is also instructed to load the predetermined operational settings into the medical imaging system, wherein each of the predetermined operational settings is selected from a plurality of potential operational settings that control operation of the medical imaging system. The computing system is also instructed to image a patient during an imaging session. The predetermined operational settings affect at least one of acquisition of a medical image during the imaging session or information that is displayed to the operator during the imaging session.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the inventive subject matter without departing from its scope. While the dimensions and types of materials described herein are intended to define the parameters of various embodiments, they are by no means limiting and are only example embodiments. Many other embodiments will be apparent to those of skill in the art upon reviewing the above description. The scope of the present application should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

This written description uses examples to disclose the various embodiments, including the best mode, and also to enable any person skilled in the art to practice the various embodiments, including making and using any devices or systems and performing any incorporated methods. The patentable scope of the various embodiments is defined by the claims, and may include other examples that occur to those skilled in the art. Such other examples are intended to be within the scope of the claims if the examples have structural elements that do not differ from the literal language of the claims, or if the examples include equivalent structural elements with insubstantial differences from the literal languages of the claims.

What is claimed is:

1. A medical imaging system comprising:
a user interface configured to receive user inputs from an operator, the user inputs comprising identification data that identifies the operator, the user interface including an operator display configured to display information to the operator during an imaging session; and
a system controller configured to control operation of the medical imaging system, the system controller configured to receive a user profile from a profile-storage system that is at a distinct location with respect to the medical imaging system, the user profile including predetermined operational settings that are associated with the operator, wherein each of the predetermined operational settings is selected from a plurality of potential operational settings that control operation of the medical imaging system, the system controller configured to load the predetermined operational settings of the user profile, wherein the predetermined operational settings affect at least one of acquisition of a medical image during the imaging session or how the information is displayed to the operator at the operator display during the imaging session.

2. The medical imaging system of claim 1, wherein the operator is a first operator, the system controller is configured to receive another user profile from the profile-storage system, the other user profile including predetermined operational settings that are associated with a second operator, wherein each of the predetermined operational settings of the second operator is selected from the plurality of potential operational settings, wherein at least one of the predetermined operational settings of the first operator is different from the predetermined operational settings of the second operator.

3. The medical imaging system of claim 1, wherein the user inputs include an operational input that instructs the system controller to change, during the imaging session, at least one of the predetermined operational settings to a different operational setting that is among the plurality of potential operational settings.

4. The medical imaging system of claim 1, wherein the system controller includes an identification module configured to transmit a request to the profile-storage system, the request including data for identifying the user profile associated with the operator.

5. The medical imaging system of claim 1, wherein the medical imaging system is an ultrasound system that includes an ultrasound probe operably coupled to the system controller, wherein operation of the ultrasound probe is controlled by the system controller.

6. The medical imaging system of claim 5, wherein the operational settings affect at least one of (a) ultrasound signals that are transmitted by the probe or (b) processing of ultrasound signals received by the probe.

7. The medical imaging system of claim 5, wherein the operational settings affect how the information is displayed to the operator.

8. The medical imaging system of claim 1, wherein the system controller includes a data-removal module that is configured to process image data to remove identifying information of a patient that is associated with the image data, the user inputs including data-removal inputs that instruct the data-removal module to generate an anonymous image with the identifying information removed.

9. A personal communication device comprising:
a portable housing that is dimensioned to be carried by an operator;
a user interface coupled to the housing and configured to receive user inputs from the operator, the user inputs comprising identification data that identifies the operator, the user interface including a personal display configured to display information to the operator;
a communication port coupled to the housing and configured to communicate with a medical imaging system; and
a device storage component coupled to the housing and configured to store a user profile, the user profile including predetermined operational settings that are associated with the operator, wherein each of the predetermined operational settings is selected from a plurality of potential operational settings that control operation of the medical imaging system, the system controller configured to transmit the user profile to the medical imaging system, wherein the predetermined operational settings affect at least one of acquisition of a medical image during the imaging session or how the information is displayed to the operator during the imaging session.

10. The personal communication device of claim 9, wherein the device storage component is configured to receive an anonymous image, the anonymous image being a medical image of a patient in which identifying information of the patient has been removed, the user interface configured to display the anonymous image.

11. The personal communication device of claim 9, wherein the user profile is directed to a first type of examination, the device storage component configured to store another user profile that is directed to a different second type of examination, the other user profile including predetermined operational settings that are associated with the operator for the second type of examination, wherein the first and second types of examination are performed by a common imaging modality.

12. The personal communication device of claim 9, wherein the medical imaging system is an ultrasound system and the operational settings affect ultrasound signals that are transmitted and/or received by an ultrasound probe.

13. The personal communication device of claim 9, wherein the operational settings determine how the information is displayed to the operator.

14. The personal communication device of claim 9, further comprising an application module that is configured to receive a user-profile request from the medical imaging system, the application module configured to transmit the user profile in response to the user-profile request.

15. The personal communication device of claim 14, wherein the user-profile request identifies the medical imaging system to be used during the imaging session, the user profile being selected from a plurality of user profiles based on the identified medical imaging system.

16. A method comprising:
receiving user inputs from an operator at a user interface of a medical imaging system, the user inputs including identification data that identifies the operator;
receiving, at the medical imaging system, a user profile from a profile-storage system that is at a distinct location with respect to the medical imaging system, the user profile including predetermined operational settings that are associated with the operator;
loading the predetermined operational settings into the medical imaging system, wherein each of the predetermined operational settings is selected from a plurality of potential operational settings that control operation of the medical imaging system; and
imaging a patient during an imaging session, wherein the predetermined operational settings affect at least one of acquisition of a medical image during the imaging session or how information is displayed to the operator during the imaging session.

17. The method of claim 16, further comprising requesting the user profile from the profile-storage system, wherein the requesting includes transmitting information for identifying the user profile.

18. The method of claim 16, further comprising permitting the operator to change, during an imaging session, at least one of the predetermined operational settings to a different operational setting that is among the plurality of potential operational settings.

19. The method of claim 16, further comprising generating an anonymous image based on an acquired medical image at the medical imaging system, wherein the anonymous image has identifying information associated with the patient removed.

20. The method of claim 16, wherein the medical imaging system is an ultrasound system that includes an ultrasound probe operably coupled to the system controller.
